(19) United States
(12) Patent Application Publication
(10) Pub. No.: US 2011/0308557 A1
(43) Pub. Date: Dec. 22, 2011

(54) Combination Anti-Microbial Drain Pan Float and High Temperature Brine Injected Automated Drain Cleaner

(76) Inventor: Stewart Kaiser, Boca Raton, FL (US)

(21) Appl. No.: 12/960,752

(22) Filed: Dec. 6, 2010

Related U.S. Application Data
(63) Continuation-in-part of application No. 12/958,466, filed on Dec. 2, 2010.
Application No. 12/958,466 is a continuation-in-part of application No. 12/816,430, filed on Jun. 16, 2010.

(51) Int. Cl. B08B 3/00

(52) U.S. Cl. 134/56 R; 134/198; 134/110

(57) ABSTRACT

The invention is directed toward a brine injector for sanitizing a condensate drain to reduce sludge and pathogens. The bring injector, which attaches to a spray assembly within the condensate drain, supplies brine (23.3% sodium chloride and 76.7% hot water) into the a saddle valve of the spray assembly. The brine injector may include a brine reservoir having a polyethylene non-corrosive coating, a pump to draw brine out of the brine reservoir, and a filter casing. The filter casing is coated with a polyethylene interior lining. Filter casing further includes 15-micron nickel copper alloy weaved filter cloth. The brine reservoir may include an electric heater to heat the brine prior to injection. A main controller communicates with the treatment chamber and spray assembly. Such main controller is capable of engaging the spray assembly to disperse a sufficient quantity and pressure of hot water within the shaft to dislodge any sludge.

### CROSS-REFERENCE TO RELATED APPLICATIONS

This is a continuation-in-part of application Ser. No. 12/958,466 entitled “Anti-Microbial Drain Pan Float” filed on Dec. 2, 2010, which in turn is a continuation-in-part application of Ser. No. 12/816,430 entitled “Self-Sanitizing Automated Condensate Drain Cleaner and Related Method of Use” filed on Jun. 16, 2010, the contents of which are incorporated by reference herein.

### FIELD OF THE INVENTION

This invention is directed toward a two-part assembly for automatically treating a condensate drain found in both commercial and residential air conditioning system. More specifically, the invention teaches a pre-treatment system including an anti-microbial drain pan float, followed by a post-treatment high temperature brine solution that is periodically blasted into the condensate drain to remove sludge build-up.

### BACKGROUND OF THE INVENTION

Apart from cooling air for circulation within a home or commercial facility, centralized air conditioners also produce condensate as a byproduct. Such condensate is created from the cooling of humid air, typically drawn from outside of the home or facility, upon treatment by the central air conditioner. Most modern central air conditioning systems include a drain pan to collect this byproduct, which in turn is fed into a condensate for transport and removal outside of the home or facility. Such systems typically include a drain pan which includes an intake to feed into a condensate drain. Often, the condensate drain includes a drain line which creates a conduit for removing condensate byproduct from the centralized air conditioner to a lawn, gutter or sewage treatment system.

One of the more common problems with centralized air conditioners is the frequent clogging of condensate drains. Typically, the clogging stems from the build-up of debris in the form of organic matter such as mold—which can include pathogens and bacteria. Such debris (aka “slime”) typically builds over time within the drain pan, due to the warm and moist conditions within the condensate drain. This build up creates not only a health hazard but also may cause the air conditioning system to malfunction and fail. Once this debris flows into the accumulation of debris within the drain pan (and later within the condensate drain) is known to cause colds, increase risk of asthma, cause fatigue, increased allergies, and even risk of Legionnaire's disease (Legionella bacteria).

Often, central air conditioning systems include a sensor in the event that a closed condensate drain risks back up of condensate byproduct. These sensors will effectively shut down and render the air conditioning system inoperable—until the line is unclogged and treated. This protocol ensures that the back-up would not ultimately cause a catastrophic failure of the air conditioning system.

Once the air conditioning system shuts down, current methods require that both the drain pan and the condensate drain be manually cleaned. This can require the use of hoses, air pressure or snakes to be introduced to the condensate line to remove the obstruction or occlusion causing the back-up. Often, this will require the services of a service technician. The result is a temporary loss of air conditioning and a risk of mold growth within the home, as well as the costs associated with hiring the service technician.

Moreover, removing an obstruction within a condensate drain through manual effort fails to prevent future clogs. This is because the drain pan will simply resume growth of mold as well as accumulation of debris from the air conditioning coils. In many cases future clogs will return—as the same conditions typically exist for additional accumulation of debris (i.e., humidity, warm temperatures, low light). The result is routine manual maintenance of these condensate drains and drain pans, which typically requires spending hundreds of dollars every year on hiring service technicians. This especially holds true in humid and warm climates like the Southeast United States.

The location and positioning of these condensate drains and pans based upon modern construction standards only further complicates these issues. Many condominium and townhouses are now constructed to hide the condensate drains within the walls—and often the load bearing walls—of these dwellings. This makes it difficult if not impossible to replace these condensate drains. Accordingly, this makes routine maintenance of these systems even more important.

Currently, the main form of home treatment for condensate drains is use of strong chemicals like BenzylAmmonium Chloride. Treatment of the condensate drains requires manual removal and use of similar strong chemicals. These strong chemicals are placed within tablets which are placed within the condensate pan, for absorption by the condensate byproduct—which in turn will treat debris throughout the condensate drain. One of the several drawbacks of employing these strong chemicals is two-fold. First, the chemicals create a large safety hazard. For example, BenzylAmmonium Chloride is a corrosive on the MSDS and can cause shortness of breath and a burning sensation in the throat. Long term exposure can cause coughing or wheezing.

A second limitation is that as a corrosive BenzylAmmonium Chloride can actually degrade and eat through the walls of the condensate drain after prolonged use. This in turn would limit the longevity of the condensate drain and require a full replacement (which may be difficult due to positioning within load bearing walls).

Accordingly, there is a need in the art of sanitizing condensate drains and leaning of condensate pans for a robust, safe and non-toxic form of cleaning. Moreover, such system should avoid the need for service technicians and be accomplished automatically. Finally, such a system should avoid using toxic chemicals or surfactants.

### SUMMARY OF THE INVENTION

This invention solves many of the limitations found in current condensate drain and condensate pan designs. More specifically, the invention is directed to a drain float for use in any residential or commercial air conditioning condensate drain pan. The drain plan first comprises a pivot shaft having a first end and a corresponding second end. A barbed float is connected to the second end of the pivot shaft. Such barbed float may have a buoyant drum and one or more barbs. Moreover, the buoyant drum may also include a cylinder filled with a sufficient amount of cork so as to make the barbed float buoyant. The one or more barbs may include a bent portion and a sharpened distal end. Optionally, each of the barbs may be made of titanium or a similar strong and resilient material.

Another part of the drain float is a tubular adaptor of a sufficient size to receive the first end of the pivot shaft. Such tubular adaptor may have an internal cavity with a diameter greater than the buoyant drum, as well as an opening which allows passage of condensate into a drain inlet. Optionally, the tubular adaptor may include a cylindrical sheath having an opening, a tubular portion having a circular bottom connector and an end cap, wherein the opening is of a sufficient size and dimension to receive the first end of the pivot shaft. Here, the opening is capable of receiving condensate drain for removal into the drain inlet.

The drain float may further comprise an anti-microbial coating placed on the barbed float, pivot shaft and tubular adaptor. Optionally, the anti-microbial coating may include silver ions in an inert ceramic matrix.

The drain float may be combined with a sanitation assembly, which provides secondary treatment of the condensate downstream from the drain float. Such sanitation assembly may include a treatment chamber (having a top end and a shaft) connected to the condensate drain. A spray assembly is positioned proximate to the top end of the treatment chamber, which may include a nozzle spray connected to a hot water source. Such spray assembly may also include one or more saddle valves.

An optional component to the spray assembly is a brine injector capable of supplying brine (at a concentration of 23.3% sodium chloride and 76.7% hot water) into the a saddle valve of the spray assembly via feed line. Introduction of such concentration of brine helps prevent freezing of the fluid in the condensate drain in cold weather climates, in addition to functioning as a disinfectant aide to reduce and/or impede the growth of sludge (including microbial and pathogens).

The brine injector may include a brine reservoir having a polyethylene non-corrosive coating, a pump sufficient to draw brine out of the brine reservoir, and a filter casing. Preferably, the filter casing may be coated with a polyethylene interior lining. In addition, filter casing further includes 15 micron nickel copper alloy weaved filter cloth. The brine reservoir may optionally include an electric heater capable of quickly heating the brine prior to injection.

A main controller communicates with both the treatment chamber and spray assembly. Such main controller is capable of engaging (turning on) the spray assembly to disperse a sufficient quantity and pressure of hot water within the shaft to dislodge any sludge.

Optionally, the treatment chamber may include a set of thermocouples, which includes shaft temperature thermocouples and condensate temperature thermocouples. A measuring unit may record temperatures determined by both sets of thermocouples. A temperature controller, connected to the measuring unit, saddle valves and nozzle spray, helps engage the nozzle spray of the spray assembly when necessary. A first connector and second connector are used to secure and engage the sanitation assembly to the condensate drain.

Other components of the sanitation assembly may include a water flow valve, a float control, and a check valve. The float control may include a housing, a buoy positioned within the housing, a vertical rod and a measuring sensor. The check valve can include a pivoting swivel door mounted to a swivel hinge that can rotate and shut upon sensing a pressure change within the sanitation assembly.

### BRIEF DESCRIPTION OF THE DRAWINGS

For a fuller understanding of the invention, reference is made to the following detailed description, taken in connection with the accompanying drawings illustrating various embodiments of the present invention, in which:

FIG. 1 is a top view of a traditional drain pan showing the inlet to the condensate drain;

FIG. 2 is a top view of a drain pan showing the proper positioning of the drain float proximate the inlet to the condensate drain;

FIG. 3 is a cut way view of the drain float showing its various components positioned within the drain pan;

FIG. 4 schematic that illustrates the placement of the sanitation assembly in light of a central air conditioner and drain pan;

FIG. 5 illustrates the various components of a sanitation assembly, including both controllers;

FIG. 6 illustrates a polyethylene casing of the brine injector containing high temperature brine for introduction into the saddle valve of the sanitation assembly;

FIG. 7 is a schematic showing one method of sanitizing the condensate drain through measuring temperature differentials; and

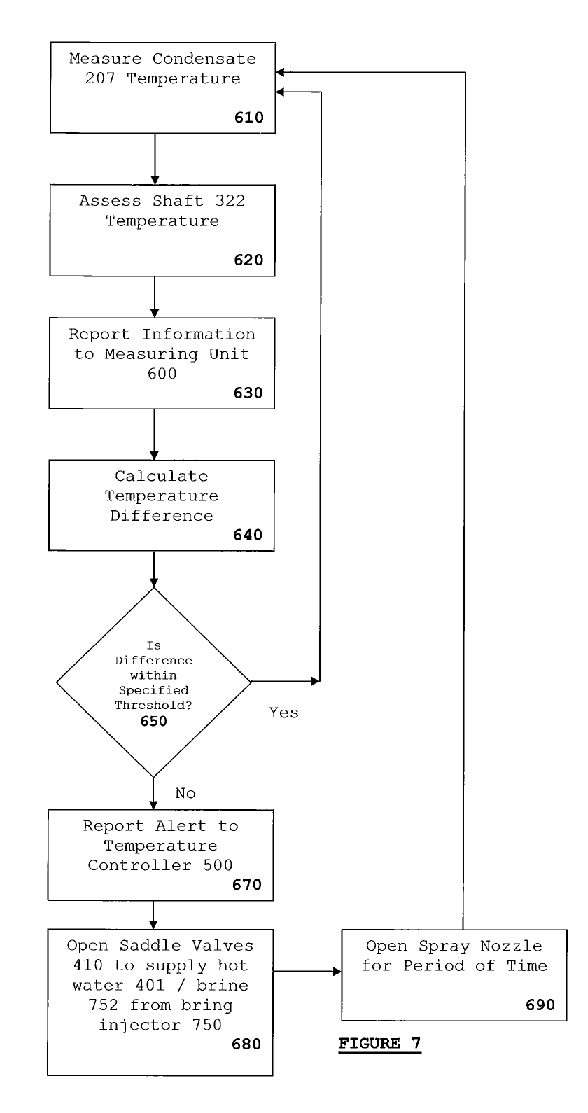

FIG. 8 is a schematic showing a second method of sanitizing the condensate drain by measuring pressure and flow rate changes within the sanitizing assembly.

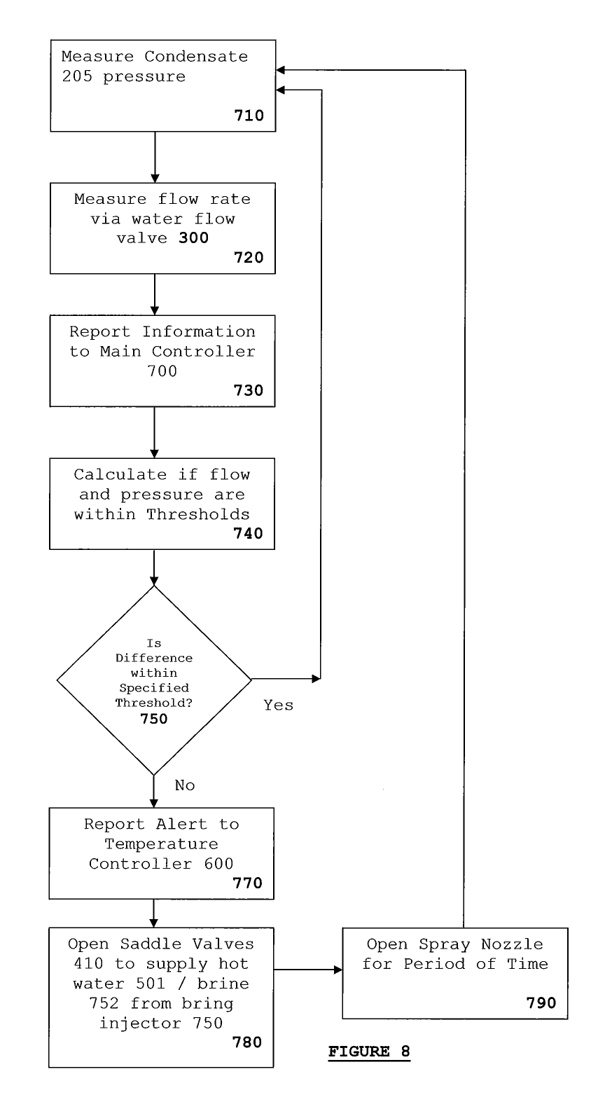

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

### The Anti-Microbial Drain Float

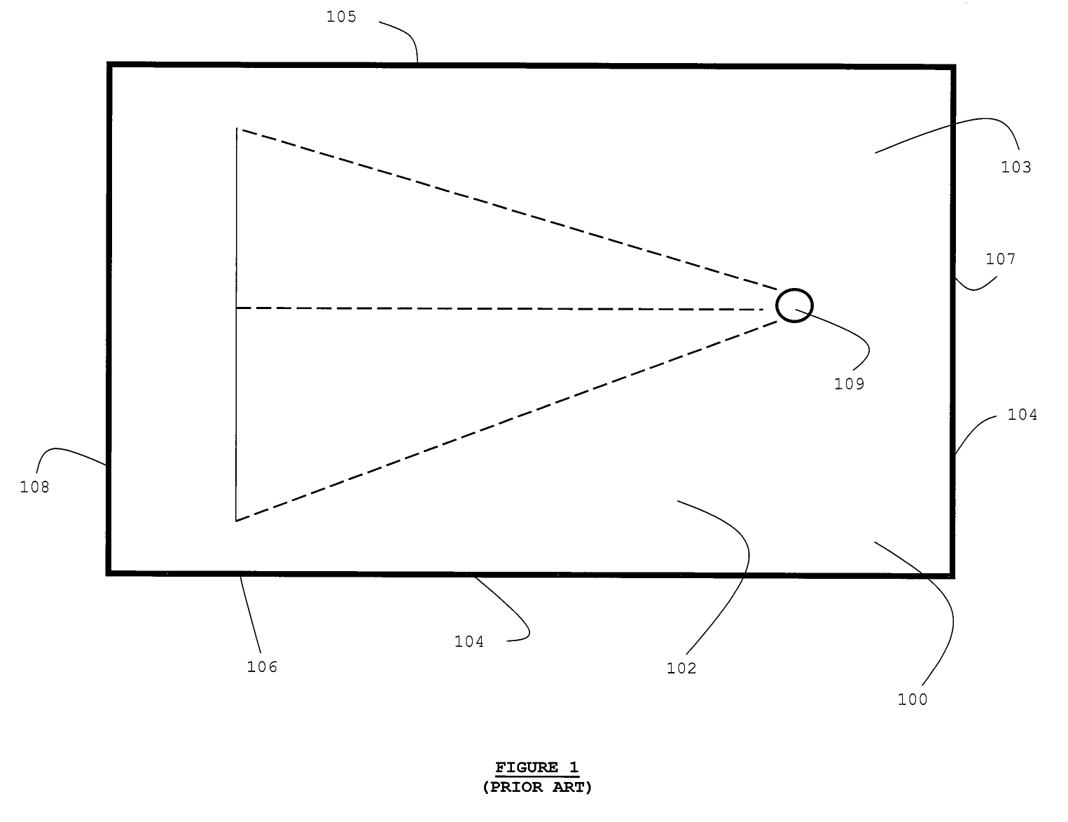

FIGS. 1 through 3 illustrate the positioning and various components 101 of the drain float 100 within a traditional air conditioning drain pan 102. FIG. 1 first illustrates the size, shape and construction of traditional drain pans 102 within a residential or commercial air conditioning system. As shown, these drain pans 102 include a drain basin 103 that contains a plurality of side walls 104. More specifically, the drain basin 103 has a top edge 105, a corresponding bottom edge 106, a right edge 107 and corresponding left edge 108. The top edge 105 and bottom edge 106 are essentially parallel to one another. Correspondingly, both the right edge 107 and left edges 108 are parallel to each other. Thus, each drain basin 103 is essentially square or rectangular in shape.

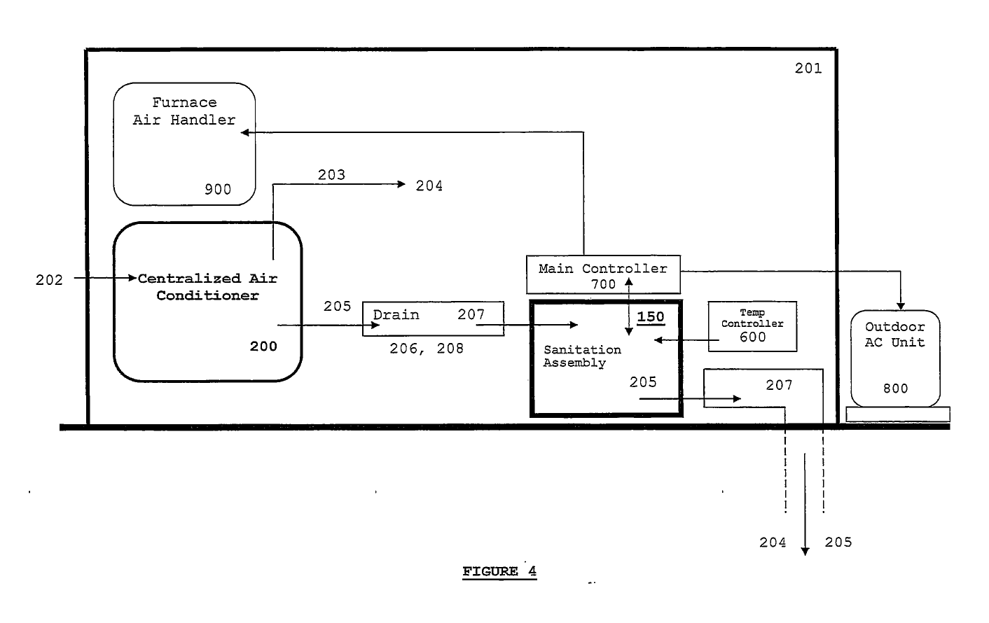

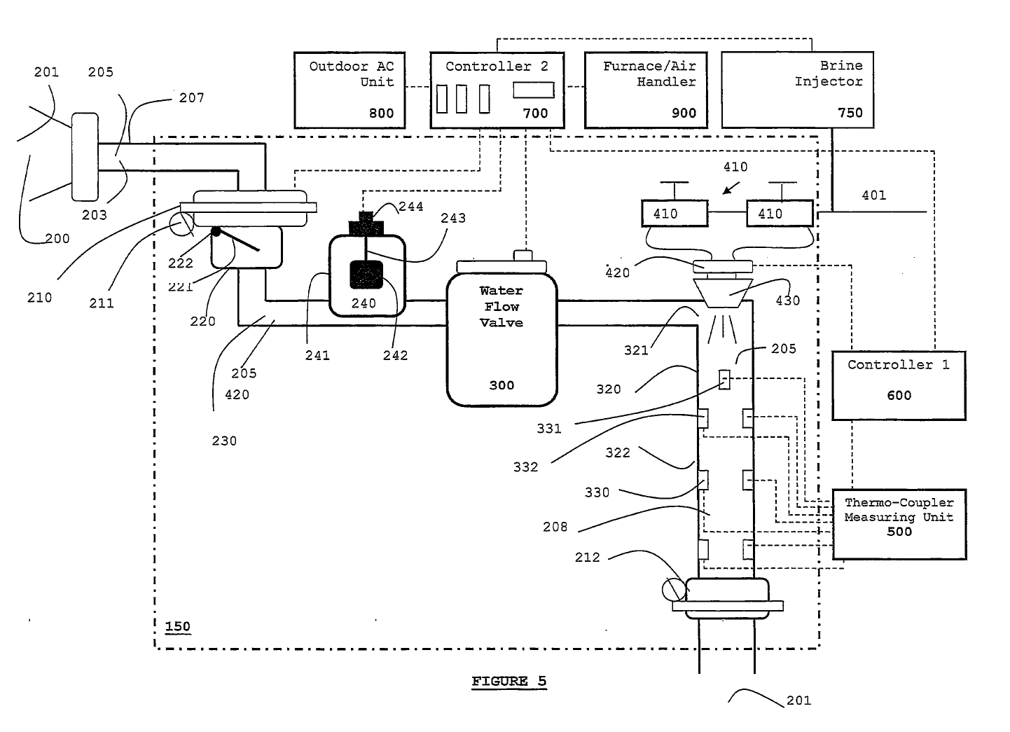

As further shown in FIG. 1, the various side walls 104 connect to the four edges 105-108 of the drain basin 103. Combination of the side walls 104 and the drain basin 103 create a water tight tray that is capable of collecting and maintaining condensate from a residential or commercial air conditioning facility. Positioned within the drain basin 103 is a drain outlet 109. The drain inlet 109 connects directly with the condensate drain 200 (described in FIGS. 4 through 5). Optionally, the drain basin 103 can include a gradient and/or directional grooves to channel accumulated condensate 205 into the drain basin 103 through the aid of gravity.

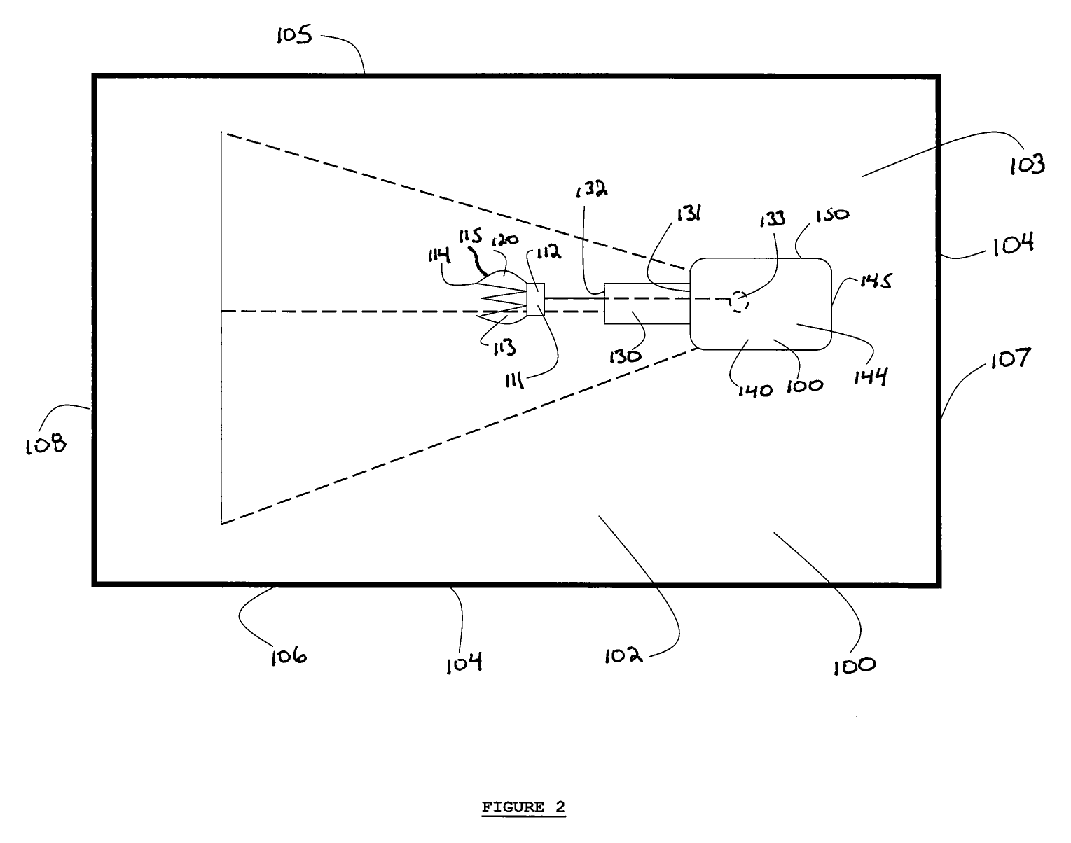

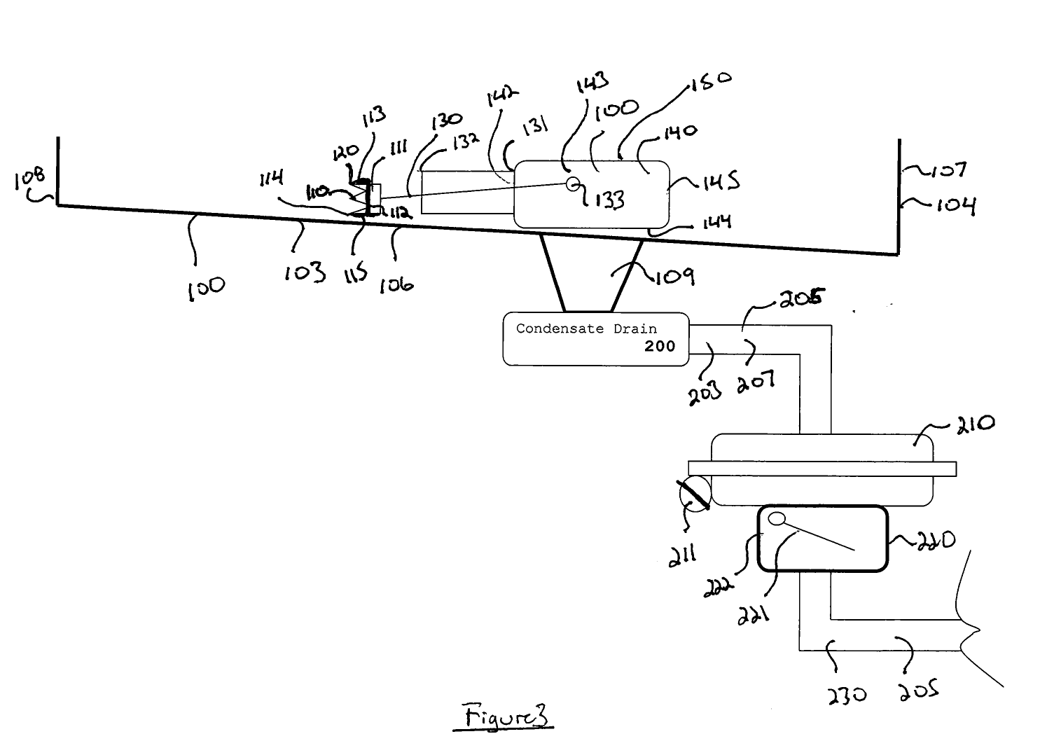

As shown and illustrated in FIG. 2, the drain float 100 is positioned directly above the drain inlet 109. Accordingly, the drain float 100 is an attachment to the drain inlet 109 such that condensate must flow through drain float 100 before it exits via the drain inlet 109 and into the condensate drain 200 (shown in FIG. 3). Moreover, FIG. 2 shows that the drain float 100 is preferably proximate the drain inlet 109 and arranged to first treat condensate prior to entry into the drain inlet 109.

While FIG. 2 illustrates the positioning of the drain float 100 in relation to the drain inlet 109, FIG. 3 identifies the salient components of the drain float 100. As shown, the drain float includes five main components: a barbed float 110, one or more barbs 120 attached to the barbed float 110, a pivot shaft 130 which connects to one end of the barbed float 110, a tubular adaptor 140 sufficient to engage the drain inlet 109, and an antimicrobial coating 150. One of ordinary skill in the art, through review of FIGS. 1 through 3 will recognize additional and/or ancillary components for the drain float 100.

As further shown in FIG. 3, the barbed float 110 includes a buoyant drum 111. While the buoyant drum 111 can be hollow, it can also be made of a buoyant material such as cork. Regardless of construction, such buoyant drum 111 should be capable of floating within condensate. Although it can be a variety of shapes and configurations, the buoyant drum 111 is preferably tubular having an outer cylinder 112.

Positioned on the surface of the outer cylinder 112 of the buoyant drum 111 are one or more barbs 120. Each barb 120 is essentially a titanium blade 113. Moreover, each barb 120 may have a sharpened distal end 114, as well as a bent portion 115. Regardless, the barb 120 should be shaped so as to help break up, loose and dislodge clumps of debris within accumulated condensate. While the barb 120 is preferably made of titanium, it can be made out of any similar strong and resilient metal.

The buoyant drum 111 is affixed to the pivot shaft 130. As shown in FIG. 3, the pivot shaft 130 includes a first end 131 and a corresponding second end 132. The second end 132 connects with outer cylinder 112, while the second end 131 connects to the tubular adaptor 140. Moreover, the second end 131 includes a pivot point 133 such that the pivot shaft 130 can pivot within the tubular adaptor 140 based upon floatation of the buoyant drum 111 within the condensate 205.

The tubular adaptor 140 is a cylindrical sheath having an opening 142, an tubular portion 143 having a circular bottom connector 144, and an end cap 145. Such tubular portion 143 has a diameter that is the same or larger than the diameter of the outer cylinder 112. The opening 142 is of a sufficient size and dimension to receive the first end 131 of the pivot shaft 130. In addition, the circular bottom connector 144 allows flow of condensate, shredded by the pivoting barbs 112, to exit the drain float 100 and into the drain inlet 109.

The outer cylinder 112 of the buoyant drum 111 and the barbs 120 are coated with an antimicrobial coating 140. Optionally, the pivot shaft 130 and the tubular portion 143 of the adaptor 140 are include the antimicrobial coating 150. Such antimicrobial coating 150 can be any material known to those of ordinary skill in the art to reduce the amount of pathogens within accumulated and sedentary condensate 205. However, the antimicrobial coating 140 is preferably is preferably made of silver ions in an inert ceramic matrix. Optionally, such antimicrobial coating 150 may also have antibacterial properties and benefits.

### Overall Positioning of Secondary Treatment System

FIG. 4 illustrates, by way of example, one preferred positioning and location of a sanitation assembly 150 which functions to provide secondary treatment of condensate downstream from the drain float 100. As shown in FIG. 4, most residential and/or commercial facilities 201 (especially those located in sub-tropical and/or warm climates) include a centralized air conditioner system 200 (hereinafter an “air conditioner”). The air conditioner 200 takes in warm moist air 202 from outside of the facility 201 and then cools that warm moist air 202. This process results in two primary byproducts 203: the first is cooled air 204, while the second is liquid condensate 205.

The condensate 205 created by the air conditioner 200 is the result of reducing the temperature of the warm most air 202, which in turn draws and accumulates the resulting water by product 203 within the system. It is important to note that condensate 205, as a byproduct 203, not only includes water but also any related matter previously dispersed within the warm moist air 202. This can include pathogens 206, but is certainly not limited to, bacteria, viruses, dust, and related particulates.

With traditional systems, the condensate 205 would be removed from the air conditioner 200 through a condensate drain 207. A condensate drain 207 is essentially a conduit and reservoir which directs condensate 205 away from the air conditioner 200 and typically drains this byproduct 203 outside of the facility 201, such as in the exterior ground or into the municipal sewage system. As previously discussed, the conditions within the condensate drain 207 (dark, humid, and warm) make it highly susceptible to the growth of pathogens 206, which can cause build-up in the form of sludge 208.

As shown and illustrated in FIG. 4, the invention contemplates positioning a sanitation assembly 150 within the condensate drain 207. There are four primary functions for the sanitation assembly 150. First, the sanitation assembly 150, as taught by the invention, detects whether there is a sufficient level of sludge 208 within the condensate drain 207—which may cause a potential health risk. Second, once detected, the sanitation assembly 150 helps break-up and remove the sludge 208 through a high pressure and temperature water spray. Third, as a result of removal of sludge 208, the sanitation assembly 150 helps reduce the overall volume of pathogens 206 within the air conditioner 200 and helps create a more sanitized and clean environment. Fourth, the sanitation assembly 150 prevents the back-up of condensate 205 within the air conditioner 200 which may risk shutting down the system and resulting in receipt of cooler air 204 within the facility 201.

Accordingly, the sanitation assembly 150 functions to remove both condensate 205 and sludge 208 away from not only the air conditioner 200 but to also remove these byproducts 204 away from the facility 201 as well.

### Components of the Sanitation Assembly

While FIG. 4 identifies one possible placement of the sanitation assembly 150 within a condensate drain 207, FIG. 5 offers, by way of example, one embodiment of the underlying components. As shown in FIG. 5, the sanitation assembly 150 attaches to the condensate drain 207 through a plurality of connectors 210. Preferably, the sanitation assembly 150 can connect through a first connector 211 and a corresponding second connector 212. The first connector 211 affixes at a point proximate to the air conditioner 200 (shown in FIG. 4).

Correspondingly, the second connector 212 attaches to that portion of the condensate drain 207 which directs condensate 205 outside and away from the facility 201. As shown in FIG. 5, the positioning and placement of both connectors 210 help balance and secure the sanitation assembly 150. While the connectors 210 can be any known system of affixing known to those of ordinary skill, they are preferably hose clamps.

Positioned below the first connector 211 is a low tension check valve 220. Preferably made of PVC, the check valve 220 preferably includes a pivoting swivel door 221 mounted to a swivel hinge 222 that can rotate and shut upon sensing a pressure change within the sanitation assembly 150. This pivoting swivel door 221 offers an important safety feature of the sanitation assembly 150. More specifically, the check valve 220 insures that upon any form of occlusion within the sanitation assembly 150, the system can seal the condensate drain 207. Examples of occlusions could include sludge 208 or some bio-material emanating from outside of the facility 201. This in turn protects the internal components of the air conditioner 200.

As further shown in FIG. 5, positioned directly below the check valve 220 is an “L” shaped feeder conduit 230. The feeder conduit 230 repositions the condensate 205 from a vertical position to a horizontal position. Put another way, so long as there is no back pressure, condensate 205 flows through the check valve 220 vertically and then is transitioned to a horizontal position.

At the end of the feeder conduit 230 is a float control 240. The float control 240 measures the pressure of the condensate 207 within the sanitation assembly 150. As shown in FIG. 5, the float control 240 includes four primary components: a housing 241, a buoy 242 positioned within the housing 241, a vertical rod 243 and a measuring sensor 244 located on top of the housing 241. As internal pressure builds, the buoy 242 rises within the housing 241, causing the vertical rod 242 to interact with the measuring sensor 243. In turn, the measuring sensor 244 can communicate with the main controller 700 (discussed in greater detail below) to address the pressure build-up.

Positioned further downstream from the float control 240 is the water flow valve 300. While the float control 240 measures the pressure of the condensate 205, the water flow valve 300 measures both the flow rate of the condensate and also regulates the flow rate to ensure proper disbursement. In addition, water flow valve 300 reports this information to the main controller 700 (again discussed in greater detail below). By assessing the water flow valve 300, the sanitation assembly 150 can assess if there is a build-up of sludge 208 (i.e., a gradual slow down of the flow rates).

### The Vertical Treatment Chamber

As also shown in FIG. 5, attached to the water flow valve 300 is a vertical treatment chamber 320. This treatment chamber 320 includes a top end 321 and an elongated shaft 322. As shown in FIG. 5, a pressure spray assembly 400 is positioned at the top end 321 of the treatment chamber 320. The spray assembly 400 includes one or more saddle valves 410, a back flow preventer 420, and a nozzle spray 430. Each saddle valve 410 connects to a hot water 401 supply (typically between 110 to 135 degrees Fahrenheit) such as a residential tankless (flash) water heater. Each saddle valve 410 feeds into the back flow preventer 420, which ensures that condensate 205 does not flow into the residential hot water 401 supply (i.e., one directional flow into the treatment chamber 320).

The hot water 401 then flows from the back flow preventer 420 to the nozzle spray 430. The nozzle spray 430 functions to inject a concentrated quantity of hot water 401 into the treatment chamber 320 to dislodge and unclog any sludge 208 within the condensate drain 207. Moreover, the nozzle spray 430 connects to the spray controller 600 (discussed in detail below)—which determines when to open each saddle valve 410 and release the hot water 401 from the nozzle spray 430.

Positioned within the shaft 322 of the treatment chamber 320 are a plurality of thermocouples 330. There are essentially two sets of thermocouples 330 positioned within the treatment chamber 320: wall temperature thermocouples 331 and condensate temperature thermocouples 332.

Both sets of thermocouples 330 are connected to a measuring unit 500—which measures the temperature differential between the wall temperature and the condensate temperature. Should the wall temperature thermocouples 331 measure a temperature different than the condensate temperature thermocouples 332, this would suggest that the shaft 322 is being insulated by debris—which likely means sludge 208 build up. Upon detecting this temperature differential, the measuring unit 500 compares this differential to a pre-specified threshold value and communicates the spray controller 600 to release the hot water 401 from the nozzle spray 430 (as described in FIGS. 3 and 4 discussed in greater detail below).

### Brine Injector

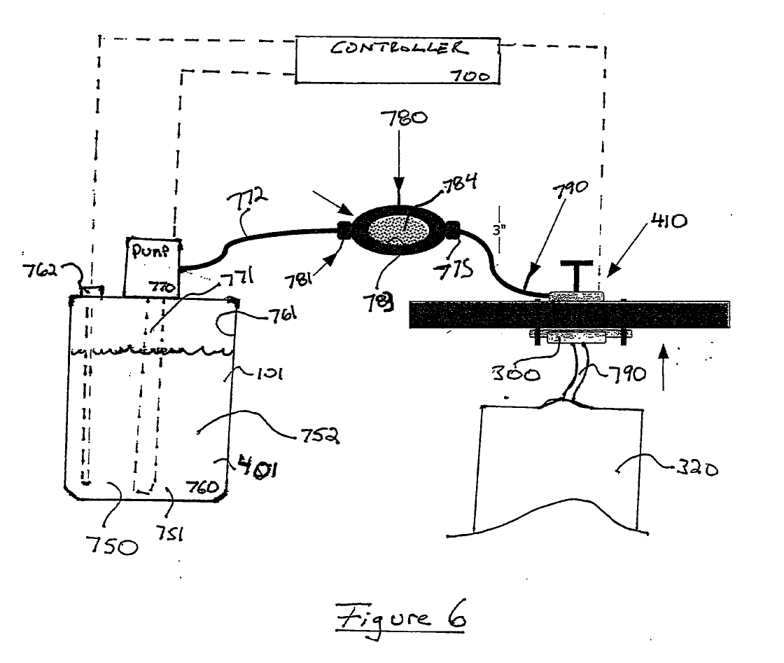

FIG. 6 illustrates, by way of example, a brine injector 750 as an optional component 101 for the sanitizing assembly 150. The brine injector 750 feeds a solution of sodium chloride 751 and high temperature water 401, i.e., brine 752, into the spray assembly 400 through a feed line 790 into one or more saddle valves 410. While a variety of concentrations of brine 752 are contemplated, it is preferred that the concentration is 23.3% sodium chloride 751 and 76.7% high temperature water 401. Such preferred concentration is such that the brine 752 has a freezing point of negative 21 degrees Celsius. Accordingly, when this concentration of brine 752 is introduced into the treatment chamber 320 (see FIG. 5) and then later cooled, it will not freeze in the pipes, thus causing a blockage or occlusion in the condensate drain 207.

As shown and illustrated in FIG. 6, the brine injector 750 includes three primary components 101: a brine reservoir 760, a pump 770 and a high pressure filter casing 780. First, the brine reservoir 760 functions to both maintain a sufficient level of brine 752 but also to heat and maintain such solution at a proscribed temperature to optimize treatment. The brine reservoir 760 is preferably non-corrosive having a polyethylene interior lining 761 sufficient to prevent rust.

Maintained within the brine reservoir 760 is an electric heater 762 that is capable of quickly heating the brine 752 prior to injection. Positioned proximate the brine reservoir 760 is a pump 770 which functions to draw heated brine 752 out of the brine reservoir 760 and into the filter casing 770. A first conduit 771 allows removal of the brine 752 for placement into the pump 770 which in turn supplies a pressurized quantity of brine 752 to the filter casing 780 via a second conduit 772. Optionally, the pump 770 can also function to draw and compress air and then immediately transport that high pressure air into the filter casing 780 and then onto the spray assembly 300. In such an embodiment, the pump 770 can include a flash heating system to immediately heat the pressurized air for introduction into the condensate drain 205. Such high temperature compressed air can be an alternative to use of brine 752—or can be used in combination with brine 752. For example, a controller 700 could instruct the brine injector 750 to supply an injection of high air and then at a later point in time an injection of brine 752. Both components would help reduce the amount of pathogens, as well as provide different physical effects in the removal of sludge build up.

The filter casing 780 includes a first compression fitting 781 which allows introduction of high pressure brine 752 from the second conduit 772. Akin to the brine reservoir 760, the filter casing 780 is coated with a polyethylene interior lining 783 sufficient to prevent rust. Positioned within the filter casing 780 is a 15 micron nickel copper alloy weaved filter cloth 784. This helps insure a constant consistency and concentration of the brine 752 prior to introduction into the spray assembly 400 (shown in FIG. 5). A second compression fitting 775 connects to the feed line 790 which in turn supplies the pressurized and high temperature brine 752 to one or more saddle valves 410.

### The Main and Spray Controllers

In addition to the sanitizing assembly 150, the invention is also directed to a main controller 700 for ensuring the integrity of the air conditioner 200 and to prevent build up of sludge 208. The main controller 700 is connected to three primary measuring devices of the sanitizing assembly 150: the check valve 220, the float control 230 and the water flow valve 330. Measuring these three devices helps the main controller 700 determine if there is a risk for back up of condensate 205 into the air conditioner 200 or slowly decreased flow rate.

In addition, the main controller 700 communicates with the spray controller 600. This allows the main controller 700 to perform scheduled and timed sprays of hot water 401 into the treatment chamber 320. In addition, the main controller 700 can record and denote the number of times the measuring unit 500 denotes a sufficient temperature difference to warrant an additional spray.

This main controller 700 also communicates with outdoor air unit 800 and air handler 900—to help increase efficiencies and record measurements.

I claim:

1. A system for sanitizing a condensate drain to reduce sludge, the system comprising:
a drain float having a pivot shaft having a first end and a corresponding second end, a barbed float connected to the second end of the pivot shaft, the barbed float having a buoyant drum and one or more barbs, and a tubular adaptor of a sufficient size to receive the first end of the pivot shaft; and
a sanitation assembly having a treatment chamber connected to the condensate drain, the treatment chamber having a top end and a shaft,
a spray assembly positioned proximate to the top end of the treatment chamber, the spray assembly having a nozzle spray connected to a brine injector, and a spray controller capable of engaging the spray assembly to disperse a sufficient quantity and pressure of hot water, brine or air within the shaft to dislodge sludge.

2. The system of claim 1, wherein the spray assembly also includes one or more saddle valves, which are connected to the nozzle spray.

3. The system of claim 2, wherein the brine injector includes a brine reservoir having a polyethylene non-corrosive coating, a pump sufficient to draw brine out of the brine reservoir, and a filter casing.

4. The system of claim 3, wherein the filter casing is coated with a polyethylene interior lining wherein the filter casing further includes 15 micron nickel copper alloy weaved filter cloth.

5. The systems of claim 4, wherein the filter casing communicates with a feed line sufficient to provide brine to the spray assembly.

6. The system of claim 4, wherein the brine reservoir includes an electric heater capable of quickly heating the brine prior to injection.

7. The system of claim 1, further comprising:
a set of thermocouples which measure temperature of the shaft as well as the condensate;
a measuring unit capable of measuring a temperature differential between the condensate and shaft; and
a temperature controller connected to measuring unit.

8. The system of claim 1, further comprising:
a first connector and a second connector sufficient to secure the sanitation assembly to the condensate drain.

9. The system of claim 1, further comprising a water flow valve.

10. The system of claim 1, further comprising a float control having a housing, a buoy positioned within the housing, a vertical rod and a measuring sensor.

11. The system of claim 1, further comprising a low tension check valve having a pivoting swivel door mounted to a swivel hinge that can rotate shut upon sensing a pressure change within the sanitation assembly.

12. A system for sanitizing a condensate drain to reduce sludge, the system comprising:
a sanitation assembly having a treatment chamber connected to the condensate drain, the treatment chamber having a top end and a shaft;
a brine injector including a brine reservoir having a polyethylene non-corrosive coating, a pump sufficient to draw brine out of the brine reservoir, and a filter casing; and
a spray assembly positioned proximate to the top end of the treatment chamber, the spray assembly having a nozzle spray connected to the brine injector, and a spray controller capable of engaging the spray assembly to disperse a sufficient quantity and pressure of hot water, brine or air within the shaft to dislodge sludge.

13. The system of claim 12, wherein the filter casing is coated with a polyethylene interior lining wherein the filter casing further includes 15 micron nickel copper alloy weaved filter cloth.

14. The systems of claim 12, wherein the filter casing communicates with a feed line sufficient to provide brine to the spray assembly.

15. The system of claim 12, wherein the spray assembly also includes one or more saddle valves, which are connected to the nozzle spray.

16. The system of claim 12, further comprising:
a set of thermocouples which measure temperature of the shaft as well as the condensate;
a measuring unit capable of measuring a temperature differential between the condensate and shaft; and
a temperature controller connected to measuring unit.

17. The system of claim 12, further comprising:
a first connector and a second connector sufficient to secure the sanitation assembly to the condensate drain.

18. The system of claim 12, further comprising a water flow valve.

19. The system of claim 12, further comprising a float control having a housing, a buoy positioned within the housing, a vertical rod and a measuring sensor.

20. The system of claim 12, further comprising a low tension check valve having a pivoting swivel door mounted to a swivel hinge that can rotate shut upon sensing a pressure change within the sanitation assembly.
